(19) United States
(12) Patent Application Publication
(10) Pub. No.: US 2011/0233025 A1
(43) Pub. Date: Sep. 29, 2011

(54) CLUTCH ACTUATING UNIT HAVING HYDRAULIC RELEASE APPARATUS

(75) Inventor: Markus HEITBAUM, BUEHLERTAL (DE)

(73) Assignee: SCHAEFFLER TECHNOLOGIES GMBH & CO. KG, (DE)

(21) Appl. No.: 13/093,952

(22) Filed: Apr. 26, 2011

Related U.S. Application Data
(63) Continuation of application No. PCT/DE2009/001357, filed on Sep. 28, 2009.

(30) Foreign Application Priority Data
Oct. 27, 2008 (DE) 10 2008 053 364.5

(51) Int. Cl. F16D 25/06; F16D 25/063

(52) U.S. Cl. 192/85.01

(57) ABSTRACT

A clutch actuating unit for a motor vehicle clutch that has a hydraulic release apparatus. The clutch actuating unit has a slave cylinder which is arranged concentric to a transmission input shaft and has a working chamber, an axially movable ring piston arranged in the slave cylinder, and a bearing flange receiving and supporting the slave cylinder. The slave cylinder is integrated into the bearing flange.

This application is a continuation of PCT/EP2009/001357 filed Sep. 28, 2009, which in turn claims the priority of DE 10 2008 053 364.5 filed Oct. 27, 2008, the priority of both applications is hereby claimed and both applications are incorporated by reference herein.

### FIELD OF THE INVENTION

The present invention relates to a clutch-actuating unit with a hydraulic release apparatus for a motor vehicle clutch.

### BACKGROUND OF THE INVENTION

A clutch-actuating unit serves mechanical separation of the clutch linings of a motor vehicle clutch in order to be able to execute a gearshift process in the transmission. The conventional mechanical release systems are increasingly being replaced by hydraulic release systems and/or release apparatus. Such hydraulic release apparatus for motor vehicle clutches are known from the prior art, hence the patent documents WO 2007/147378 A1 and EP 1 645 767 A1 of the same applicant are exemplarily cited.

FIG. 2 shows a clutch-actuating unit 100 with a hydraulic release apparatus in accordance with a current series embodiment in a sectional view. The clutch-actuating unit 100 is disposed around a rotating transmission input shaft 4 and is surrounded essentially by clutch housing and/or a clutch bell 7. The engine torque is transmitted by the crankshaft of the engine to the flywheel 1 and from there it is transmitted by means of friction linings via the clutch disk 2 under interposition of a dual mass flywheel 14 to the central transmission input shaft 4. In order to be able to interrupt the power flow and/or torque flow between the flywheel 1 and the transmission input shaft 4, a hydraulic release apparatus is provided. This comprises a concentric slave cylinder (CSC) 15 supported concentrically to the transmission input shaft 4 with a working chamber 16 in which a ring piston 12 is supported axially movably. If the working chamber 16 is subjected to pressure by means of a hydraulic fluid, then the ring piston 12 moves out of the slave cylinder 15, i.e. the ring piston 12 is moved to the left in accordance with the representation in FIG. 2 and actuates a lever acting as clutch diaphragm spring 18, through which the friction linings detach from the clutch disc 2 and release this information. After pressure relief from the working chamber 16, the ring piston 12 again moves back to the left, as result of which the friction linings are brought again in contact with the clutch disk 2. The movement of the ring piston 12 is assisted by a spring 17. In FIG. 2, the upper half of the clutch-actuating unit 100 is represented with a maximally extended ring piston 12 (max. extension), whereby this ring piston 12 is located in the lower half of the clutch-actuating unit 100 in the opposite retracted position (min. extension).

The slave cylinder and/or the CSC 15 are/is fixed on a bearing flange 9, or respectively screwed thereon, and are/is likewise supported against this bearing flange 9. The bearing flange 9 is for its part fixed on the clutch housing 7. The transmission input shaft 4 is supported via a roller bearing 6 on the bearing flange 9.

The pressure connection and/or the activation means of the slave cylinder 15 takes place via a pressure line 19. The pressure line 19 is connected to one end by means of a plug-in connection 20 with the slave cylinder 15 and has a connector 21 that establishes the connectivity of the pressure line 19 on the clutch housing 7.

What is disadvantageous about the above described clutch-actuating unit in accordance with prior art is the assembly complexity.

### SUMMARY OF THE INVENTION

One object of the invention is providing an improved clutch-actuating unit with a hydraulic release apparatus that allows particularly easy mounting.

This object is met through a clutch-actuating unit for an motor vehicle clutch with a hydraulic release apparatus, comprising a concentric slave cylinder disposed on a transmission input shaft with a working chamber, a ring piston disposed axially movably in the slave cylinder and a bearing flange that receives and supports the slave cylinder, whereby the slave cylinder is integrated in the bearing flange. The slave cylinder is particularly formed with the bearing flange as one-piece. This means that both the working chamber of the slave cylinder and the running surface of the piston and/or ring piston are formed directly inside the bearing flange.

The clutch-actuating unit according to the invention has many advantages. During the assembly of the clutch-actuating unit according to the invention the bearing flange with the integrally formed slave cylinder can be mounted virtually as one component by what means previous assembly processes are dispensed with. A pleasant side effect is also that some significant savings of components are provided. For instance, the fastening screws for the slave cylinder on the bearing flange are omitted. Based on the omission of the fastening screws, the working chamber of the slave cylinder can be formed with a larger diameter, with which for the same hydraulic pressure on the ring piston, greater actuating forces can be developed.

In accordance with a preferred embodiment, it is provided that the pressure connection and/or activation means of the slave cylinder in the bearing flange at least a fluid flow passage is formed, which extends from radial outside part towards the working chamber of the slave cylinder.

Owing to this quasi-integral formation of the pressure connection for the slave cylinder, the above described, separate pressure line and its connection to the slave cylinder can be dispensed with, which further leads to reduction of individual parts. A further advantage of this integral formation of pressure connection is that they allow substantially higher actuating rates and shorter actuating time to be possible for the hydraulic release apparatus. On the other hand in prior art, owing to small cross-sections in the pressure line and their connections only comparatively small actuating rates and associated proportionally long actuating time are possible, whereby the use of pressure lines and/or connections with a larger cross-section fails in that sufficient assembly space is not available in axial direction. On the other hand an integrally formed flow channel with a substantially larger cross-section can be formed, whereby here the “hydraulic cross-section” is decisive. Owing to this larger cross-section and/or hydraulic cross-section, substantially more hydraulic fluid CaO be brought in or out of the working chamber of the slave cylinder briefly, wherein the actuating rate increases significantly, even at low temperatures when the hydraulic fluid has more or less tenacious characteristics. Furthermore, owing to the omission of the connection of a separate pressure line to the slave cylinder, its working chamber can be formed with a larger diameter, with which significantly higher forces can be produced at the same hydraulic pressure on the ring piston. This can result in, where appropriate, the application of a weaker, lighter and more cost effective hydraulic pump.

Particularly the flow channel follows a radial contour of the bearing flange. Henceforth, also the arrangement of several, more or less parallel flow channels is possible in the bearing flange. In accordance with a preferred embodiment, it is provided that the flow channel in the bearing flange is formed through a bore and/or flow bore or through several, respectively meeting bores.

In accordance with a preferred embodiment, it is provided that the flow channel in the bearing flange is formed from radial outside part at least by one main bore and two transverse bores connected hereto. The main bore extends preferably in an essentially radial direction, the first transverse bore extends essentially in an axial direction and the second transverse bore extends essentially in a radial direction. This arrangement of bores additionally serves to reach the rear end of the working chamber of the slave cylinder facing away from the ring piston.

In accordance with a preferred embodiment hereof, it is provided that the bore entry holes of the transverse bores are closed with permanent and high pressure resistant sealing elements. These sealing elements withstand for instance an internal pressure of up to 450 bar.

In accordance with a preferred embodiment, it is provided that the bearing flange comprises a hydraulic connection for an external pressure line at its radial external end. This hydraulic connection is formed preferably as a screwable connection coupling and is screwed on the bearing flange from radially outside and/or screwed in the latter. In this way, a connector that was used previously can be dispensed with. The connection coupling extends preferably through the clutch housing. The external connection pressure line can be equipped with a beaded flange and be screwed from outside by means of a union nut including a sealing ring on the bearing flange.

In accordance with a preferable embodiment, it is provided that the running surfaces and/or sliding surfaces for the piston and/or ring piston are treated separately. This particularly involves machined smoothening, local hardening, coating or anodization.

In accordance with a preferred embodiment, it is provided that the bearing flange is formed as one piece. The bearing flange is formed particularly as casting or as a part formed from a metal or a metal alloy.

### BRIEF DESCRIPTION OF THE DRAWINGS

The present invention will be further understood and appreciated by reading the following description in conjunction with the accompanying drawings, in which:

FIG. 1 shows a sectional view of a clutch-actuating unit of the present invention; and

FIG. 2 shows a sectional view of a prior art clutch-actuating unit.

### DETAILED DESCRIPTION OF THE INVENTION

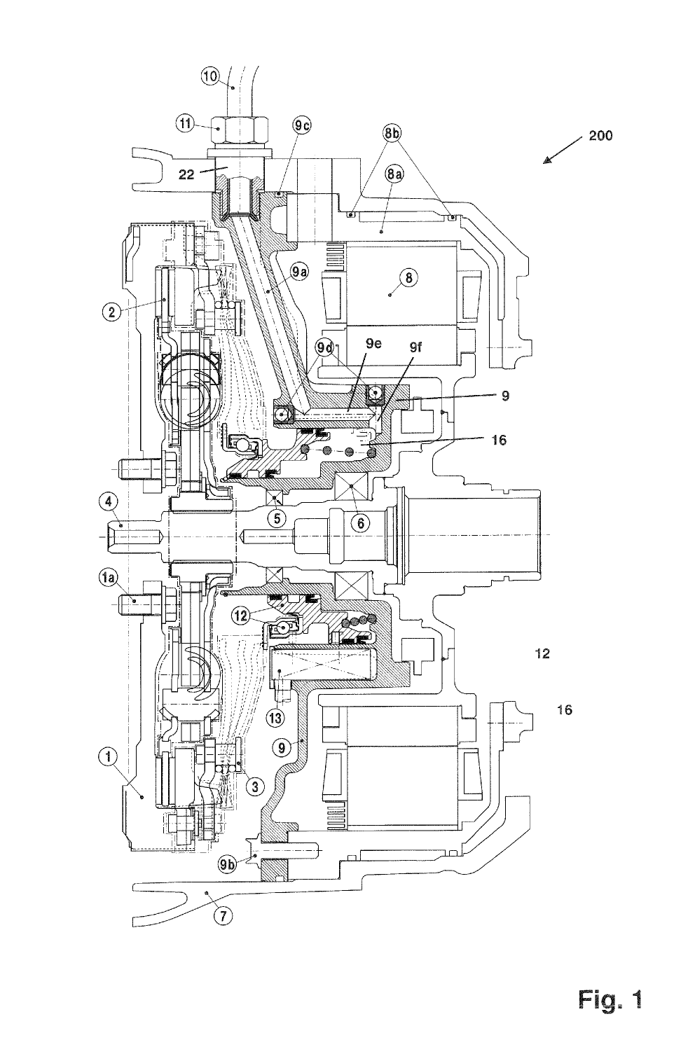

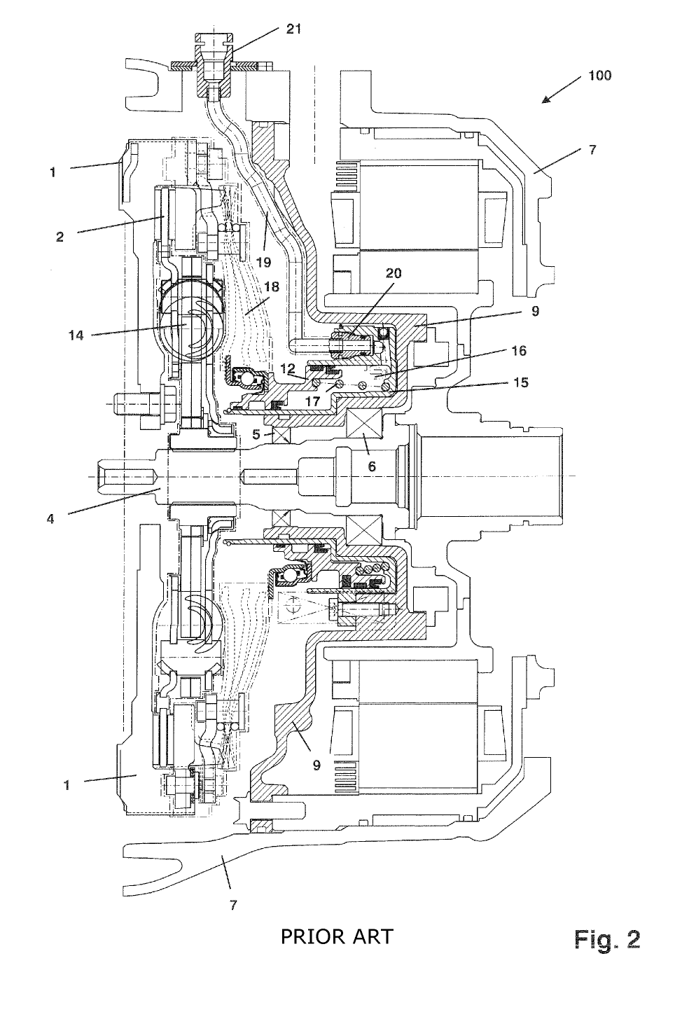

The invention is clarified below in detail based on an exemplary embodiment in association with FIG. 1, whereby essentially only the relevant differences with respect to the prior art according to FIG. 2 is dealt with. FIG. 1 shows a clutch-actuating unit 200 according to the invention, in a sectional view. The clutch-actuating unit 200 is similar in design to the clutch-actuating unit 100 in FIG. 2. The same components and parts are therefore denoted with the same reference symbols. In FIG. 1, like in FIG. 2, the upper half of the clutch-actuating unit 200 is depicted with a maximally extended ring piston 12 (max. extension), whereby this ring piston 12 is located in the lower half of the clutch-actuating unit 200 in the opposite retracted position (min. extension).

An essential difference between the clutch-actuating unit 200 according to the invention and the clutch-actuating unit 100 according to the prior art is the integral formation of the slave cylinder 15 and the bearing flange 9. In this case, the working chamber and/or the pressure chamber 16 are/is formed directly inside the bearing flange 9. The pressure connection for activating the working chamber 16 take place through a main bore 9a extending essentially radially, a first transverse bore 9e extending essentially axially and a second transverse bore 9f extending essentially radially. The bore entry holes of the transverse bores 9e and 9f are closed with permanent and high pressure resistant sealing elements 9d. The bores and/or pressure connection bores 9a, 9e and 9f form a flow channel between the rear section of the working chamber 16 and the radial external section of the bearing flange 9. At the radial external end of the bearing flange 9, a hydraulic connection coupling 22 is screwed in; it extends through the clutch housing 7, and it is durably screwed on an external bead-flanged connection pressure line 10 by means of a union nut 11 by using a sealing ring.

The bores 9a, 9e and 9f can be formed with a comparatively large diameter and/or with a large cross-section and/or hydraulic cross-section. Through it, a large quantity of hydraulic fluid can be briefly fed into or drained out of the working chamber 16, in this way high actuating rates and/or short actuating time are enabled for the hydraulic release apparatus by correspondingly fast actuating movements of the ring piston 12. Furthermore, also several parallel flow channels can be introduced into the bearing flange 9 in the above-described manner.

Through the omission of the fastening screws for the slave cylinder 15 on the bearing flange 9 as well as the omission of the connection 20 on the slave cylinder 15, more space is available in the clutch-actuating unit 200 so that the working chamber 16 can be formed with a larger diameter. In this case, also the ring piston 12 can be formed with a larger ring surface so that in at the same hydraulic pressure inside the working chamber 16, substantially higher actuating forces are reached on the ring piston 12.

As depicted, the bearing flange 9 is formed as one piece and fixed on the clutch housing 7.

### LIST OF REFERENCE SYMBOLS

1 Flywheel
1a Fastening Screw for Flywheel Crankshaft
2 Clutch Disk
3 Clutch Pressure Plate (SAC)
4 Transmission Input Shaft (Including Driving Dog and Rotor)
5 Radial Shaft Sealing Ring
6 Roller Bearing
7 Clutch Bell, Clutch Housing
8 Stator
8a Stator Housing
8b O-ring Sealing for Stator Housing
9 Bearing Flange
9a Main Bore
9b Fastening Screw for Bearing Flange
9c O-Ring Sealing for Bearing Flange
9d Permanent Sealing Element (Expander)
9e Transverse Hole
9f Transverse Bore
10 Connection Pressure Line (Beaded Flange for Steel Brake Tube)
11 Union Nut (including sealing)
12 Piston and/or Ring Piston (UZSB; including guide strips and groove sealing ring)
13 Sensor+Magnet
14 Dual Mass Flywheel
15 Slave Cylinder (CSC)
16 Working Chamber and/or Pressure Chamber (Slave Cylinder)
17 Spring
18 Clutch Diaphragm Spring
19 Pressure Line
20 Connection
21 Connector
22 Hydraulic Connection Coupling
100 Clutch-Actuating Unit (Prior Art)
200 Clutch-Actuating Unit

1-9. (canceled)

10. A clutch-actuating unit for a motor vehicle clutch with a hydraulic release apparatus, comprising:
a slave cylinder having a working chamber disposed concentrically to a transmission input shaft;
an axially movable ring piston disposed in the slave cylinder; and
a bearing flange receiving and supporting the slave cylinder,
wherein the slave cylinder is integrated in the bearing flange.

11. The clutch-actuating unit according to claim 10, wherein the slave cylinder is formed with the bearing flange as one piece.

12. The clutch-actuating unit according to claim 11, further comprising a working chamber and a flow channel, the flow channel activates the slave cylinder in the bearing flange that extends radially outside towards the working chamber.

13. The clutch-actuating unit according to claim 12, wherein the flow channel is formed through a bore or through several meeting bores.

14. The clutch-actuating unit according to claim 12, wherein the flow channel is formed from radially outside through at least a main bore and two adjoining transverse bores.

15. The clutch-actuating unit according to claim 14, further comprising permanent, high-pressure resistant sealing elements, wherein the transverse bores having bore entry holes are sealed with the permanent, high-pressure resistant sealing elements.

16. The clutch-actuating unit according to claim 10, further comprising an external connection pressure line, wherein the bearing flange has a hydraulic connection for the external connection pressure line on a radial external end, and whereby the hydraulic connection is a screwable connection coupling and is screwed from a radial outside position into the bearing flange.

17. The clutch-actuating unit according to claim 10, wherein the ring piston has running surfaces and the running surfaces are separately treated.

18. The clutch-actuating unit according to claim 10, wherein the bearing flange is one piece.
